(19) United States
(12) Patent Application Publication
(10) Pub. No.: US 2007/0251450 A1
(43) Pub. Date: Nov. 1, 2007

(54) Systems and Methods for Monitoring and Controlling Dispense Using a Digital Optical Sensor

(75) Inventor: Y. Sean LIN, IRVINE, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: APPLIED MATERIALS, INC., SANTA CLARA, CA (US)

(21) Appl. No.: 11/380,910

(22) Filed: Apr. 28, 2006

(51) Int. Cl. B05C 11/00; B05C 5/00

(52) U.S. Cl. 118/684; 118/712; 118/300; 118/694; 222/1

(57) ABSTRACT

A device for detection of a semiconductor process liquid is provided. The device includes a light source adapted to generate a light beam and a digital optical sensor to detect the light beam. A nozzle is adapted to support the semiconductor process liquid and transmit the light beam. The nozzle and the source are arranged to refract the beam in a first direction while the beam passes through a gas disposed in the nozzle. The nozzle and source are arranged to refract the beam in a second direction while the beam passes through the liquid.

### BACKGROUND OF THE INVENTION

The present invention relates generally to the field of substrate processing equipment. More particularly, the present invention relates to a method and apparatus for providing delivery, monitoring and detection of dispense errors, with fluids used for semiconductor process chemistry. Merely by way of example, the method and apparatus of the present invention are used to deliver, dispense and detect liquids, for example photoresist in a delivery nozzle, dispensed in a photolithography coating system. The method and apparatus can be applied to other processes for semiconductor substrates, for example those used in the formation of integrated circuits.

Modern integrated circuits contain millions of individual elements that are formed by patterning the materials, such as silicon, metal and/or dielectric layers, that make up the integrated circuit to sizes that are small fractions of a micrometer. The technique used throughout the industry for forming such patterns is photolithography. A typical photolithography process sequence generally includes depositing one or more uniform photoresist (resist) layers on the surface of a substrate, drying and curing the deposited layers, patterning the substrate by exposing the photoresist layer to electromagnetic radiation that is suitable for modifying the exposed layer and then developing the patterned photoresist layer.

It is common in the semiconductor industry for many of the steps associated with the photolithography process to be performed in a multi-chamber processing system (e.g., a cluster tool) that has the capability to sequentially process semiconductor wafers in a controlled manner. One example of a cluster tool that is used to deposit (i.e., coat) and develop a photoresist material is commonly referred to as a track lithography tool.

Track lithography tools typically include a mainframe that houses multiple chambers (which are sometimes referred to herein as stations) dedicated to performing the various tasks associated with pre- and post-lithography processing. There are typically both wet and dry processing chambers within track lithography tools. Wet chambers include coat and/or develop bowls, while dry chambers include thermal control units that house bake and/or chill plates. Track lithography tools also frequently include one or more pod/cassette mounting devices, such as an industry standard FOUP (front opening unified pod), to receive substrates from and return substrates to the clean room, multiple substrate transfer robots to transfer substrates between the various chambers/stations of the track tool and an interface that allows the tool to be operatively coupled to a lithography exposure tool in order to transfer substrates into the exposure tool and receive substrates from the exposure tool after the substrates are processed within the exposure tool.

Over the years there has been a strong push within the semiconductor industry to shrink the size of semiconductor devices. The reduced feature sizes have caused the industry's tolerance to process variability to shrink, which in turn, has resulted in semiconductor manufacturing specifications having more stringent requirements for process uniformity and repeatability. An important factor in minimizing process variability during track lithography processing sequences is to ensure that every substrate processed within the track lithography tool for a particular application has the same “wafer history.” A substrate's wafer history is generally monitored and controlled by process engineers to ensure that all of the device fabrication processing variables that may later affect a device's performance are controlled, so that all substrates in the same batch are always processed the same way.

A component of the “wafer history” is the thickness, uniformity, repeatability, and other characteristics of the photolithography chemistry, which includes, without limitation, photoresist, developer, and solvents. Generally, during photolithography processes, a substrate, for example a semiconductor wafer, is rotated on a spin chuck at predetermined speeds while liquids and gases such as solvents, photoresist (resist), developer, and the like are dispensed onto the surface of the substrate. Typically, the wafer history will depend on the process parameters associated with the photolithography process.

As an example, an inadequate volume of photoresist dispensed during a coating operation will generally impact the uniformity and thickness of coatings formed on the substrate. Additionally, the dispense rate of the photoresist will generally impact film properties, including the lateral spreading of the resist in the plane of the substrate. In some instances, therefore, it is desirable to control both the volume and dispense rate of the photoresist applied to the substrate with respect to both the accuracy (e.g., total volume per dispense event) and repeatability (e.g., difference in volume per dispense over a series of dispense events) of the dispense process.

Work in relation to the present invention suggests that known methods of monitoring and dispensing liquids may be less than ideal. For example, known systems and methods for controlling fluid dispense from a nozzle close a flow valve and suck fluid back at the same time. Such systems can be difficult to diagnose and tune as it can be unclear to an operator whether the flow valve or suck back valve is contributing to observed system behavior. Also, it could be beneficial to provide real time detection of system failure or real time detection of warning signals indicating imminent failure. Accordingly, further improvements are desired and are continuously sought by process engineers. Therefore, there is a need in the art for improved methods and apparatus for controlling the dispensed liquids in a photolithography system.

### BRIEF SUMMARY OF THE INVENTION

According to the present invention, techniques related to the field of semiconductor processing equipment are provided. More particularly, the present invention includes a method and apparatus for providing delivery, monitoring and detection of dispense errors, with fluids used for semiconductor process chemistry. Merely by way of example, the method and apparatus of the present invention have been applied to delivery, dispense and detection liquids, for example photoresist in a delivery nozzle, dispensed in a photolithography coating system. The method and apparatus can be applied to other processes for semiconductor substrates, for example those used in the formation of integrated circuits.

In a specific embodiment of the present invention, a device for detection of a semiconductor process liquid is provided. The device includes a light source adapted to generate a light beam and a digital optical sensor to detect the light beam. A nozzle is adapted to support the semiconductor process liquid and transmit the light beam. The nozzle and the source are arranged to refract the beam in a first direction while the beam passes through a gas disposed in the nozzle. The nozzle and source are arranged to refract the beam in a second direction while the beam passes through the liquid.

In another embodiment, a device for detecting delivery errors with a semiconductor process liquid is provided. A nozzle is adapted to deliver the liquid, and the nozzle comprises a tip. A flow valve is coupled to the nozzle to dispense the liquid through the nozzle. A suck back valve is adapted to suck the liquid back from the nozzle tip. A digital optical sensor is adapted to detect the liquid or a gas in the nozzle, the sensor adapted to generate a first signal while the liquid is disposed in the nozzle and a second signal while a gas is disposed in the nozzle. A processor is coupled to the sensor, and the processor is adapted to generate an error signal. The signal is generated in response to the second signal from the sensor while the flow valve dispenses liquid through the nozzle or in response to the first signal from the sensor while the suck back valve has sucked the liquid back from the tip.

In additional embodiments, a method of applying a semiconductor process liquid through a nozzle is provided. A flow valve is opened to dispense the liquid through the nozzle. The flow valve is closed to stop the liquid in the nozzle at a first level, and the first level is near a tip of the nozzle. The liquid is drawn back from the first level toward a second level away from the tip with a suck back valve while the flow valve remains closed. The liquid is advanced from the second level to the first level with the suck back valve to reset liquid at the first level.

Many benefits are achieved by way of the present invention over conventional techniques. For example, an embodiment provides a device for automatic detection of a semiconductor process liquid with a digital optical sensor. A particular embodiment provides a digital optical sensor to detect liquid in a nozzle in which the sensor generates a first signal while liquid is disposed in the nozzle and a second signal while a gas is disposed in the nozzle so that errors in dispensing a process liquid can be easily detected. Furthermore, some embodiments provide a method of dispensing a semiconductor process liquid which facilitates diagnosis and tuning of the dispense apparatus. Depending upon the embodiment, one or more of these benefits, as well as other benefits, may be achieved. These and other benefits will be described in more detail throughout the present specification and more particularly below in conjunction with the following drawings.

### BRIEF DESCRIPTION OF THE DRAWINGS

FIG. 1 is a simplified plan view of an embodiment of a track lithography tool according to an embodiment of the present invention;

FIG. 2 is a simplified schematic illustration of a photolithography chemical dispense apparatus according to an embodiment of the present invention;

FIG. 3A is a simplified schematic illustration of digital optical sensor to detect liquid in a nozzle of a dispense apparatus according to an embodiment of the present invention;

FIG. 3B shows a light beam transmitted from a light source to a sensor in a first direction a while gas is disposed in the nozzle of FIG. 3A according to an embodiment of the present invention;

FIG. 3C shows the light beam of FIG. 3B refracted in a second direction away from the sensor while liquid is disposed in the nozzle of FIG. 3A according to an embodiment of the present invention;

FIG. 3D shows a simplified schematic illustration of a liquid in a nozzle drawn above a digital optical sensor to detect gas according to an embodiment of the present invention;

FIG. 3E shows a simplified schematic illustration of a liquid in a nozzle drawn above a tip of a nozzle and below a digital optical sensor according to an embodiment of the present invention;

FIG. 3F shows a simplified schematic illustration of a liquid in a nozzle flush with a tip of the nozzle and below a digital optical sensor according to an embodiment of the present invention;

FIG. 4A illustrates a graph of an internal sensor voltage versus liquid height above a nozzle for a light sensor with an adjustable threshold according to an embodiment of the present invention;

FIG. 4B illustrates a graph of an external digital line voltage versus liquid height above a nozzle;

FIG. 5A shows a timing diagram which illustrates opening a valve with a control signal according to an embodiment of the present invention;

FIG. 5B shows a timing diagram which illustrates sequentially closing a flow valve and then exhausting a suck back valve after a period of time according to an embodiment of the present invention;

FIG. 6 shows a flow chart illustrating a method of tuning a liquid delivery apparatus according to an embodiment of the present invention;

FIG. 7A shows a method of dispensing a semiconductor process liquid to a substrate and detecting errors according to an embodiment of the present invention; and

FIG. 7B shows sequential pictures from a method as in FIG. 7A with a nozzle in which no error has occurred according to an embodiment of the present invention.

### DESCRIPTION OF SPECIFIC EMBODIMENTS

According to the present invention, techniques related to the field of semiconductor processing equipment are provided. More particularly, the present invention includes a method and apparatus for providing delivery, monitoring and detection of dispense errors, with fluids used for semiconductor process chemistry. Merely by way of example, the method and apparatus of the present invention have been applied to delivery, dispense and detection liquids, for example photoresist in a delivery nozzle, dispensed in a photolithography coating system. The method and apparatus can be applied to other processes for semiconductor substrates, for example those used in the formation of integrated circuits.

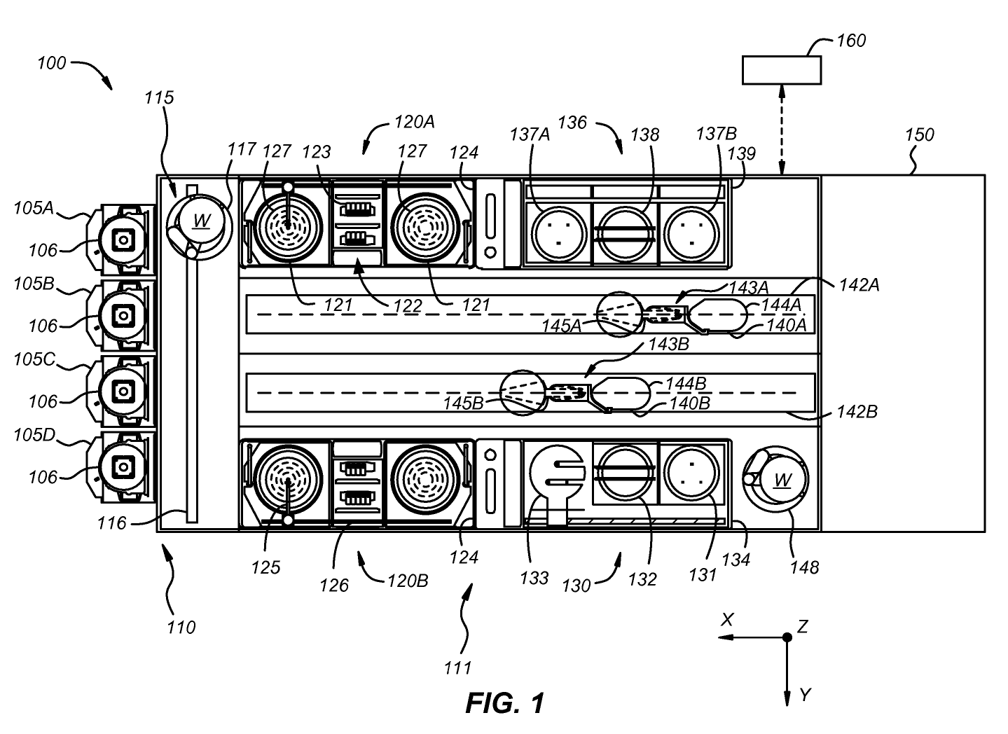

FIG. 1 is a plan view of an embodiment of a track lithography tool 100 in which the embodiments of the present invention may be used. As illustrated in FIG. 1, track lithography tool 100 contains a front end module 110 (sometimes referred to as a factory interface or FI) and a process module 111. In other embodiments, the track lithography tool 100 includes a rear module (not shown), which is sometimes referred to as a scanner interface. Front end module 110 generally contains one or more pod assemblies or FOUPS (e.g., items 105A-D) and a front end robot assembly 115 including a horizontal motion assembly 116 and a front end robot 117. The front end module 110 may also include front end processing racks (not shown). The one or more pod assemblies 105A-D are generally adapted to accept one or more cassettes 106 that may contain one or more substrates or wafers, “W,” that are to be processed in track lithography tool 100. The front end module 110 may also contain one or more pass-through positions (not shown) to link the front end module 110 and the process module 111.

Process module 111 generally contains a number of processing racks 120A, 120B, 130, and 136. As illustrated in FIG. 1, processing racks 120A and 120B each include a coater/developer module with shared dispense 124. A coater/developer module with shared dispense 124 includes two coat bowls 121 positioned on opposing sides of a shared dispense bank 122, which contains a number of nozzles 123 providing processing fluids (e.g., bottom anti-reflection coating (BARC) liquid, resist, developer, and the like) to a wafer mounted on a substrate support 127 located in the coat bowl 121. In the embodiment illustrated in FIG. 1, a dispense arm 125 sliding along a track 126 is able to pick up a nozzle 123 from the shared dispense bank 122 and position the selected nozzle over the wafer for dispense operations. Of course, coat bowls with dedicated dispense banks are provided in alternative embodiments.

Processing rack 130 includes an integrated thermal unit 134 including a bake plate 131, a chill plate 132, and a shuttle 133. The bake plate 131 and the chill plate 132 are utilized in heat treatment operations including post exposure bake (PEB), post-resist bake, and the like. In some embodiments, the shuttle 133, which moves wafers in the x-direction between the bake plate 131 and the chill plate 132, is chilled to provide for initial cooling of a wafer after removal from the bake plate 131 and prior to placement on the chill plate 132. Moreover, in other embodiments, the shuttle 133 is adapted to move in the z-direction, enabling the use of bake and chill plates at different z-heights. Processing rack 136 includes an integrated bake and chill unit 139, with two bake plates 137A and 137B served by a single chill plate 138.

One or more robot assemblies (robots) 140 are adapted to access the front-end module 110, the various processing modules or chambers retained in the processing racks 120A, 120B, 130, and 136, and the scanner 150. By transferring substrates between these various components, a desired processing sequence can be performed on the substrates. The two robots 140 illustrated in FIG. 1 are configured in a parallel processing configuration and travel in the x-direction along horizontal motion assembly 142. Utilizing a mast structure (not shown), the robots 140 are also adapted to move in a vertical (z-direction) and horizontal directions, i.e., transfer direction (x-direction) and a direction orthogonal to the transfer direction (y-direction). Utilizing one or more of these three directional motion capabilities, robots 140 are able to place wafers in and transfer wafers between the various processing chambers retained in the processing racks that are aligned along the transfer direction.

Referring to FIG. 1, the first robot assembly 140A and the second robot assembly 140B are adapted to transfer substrates to the various processing chambers contained in the processing racks 120A, 120B, 130, and 136. In one embodiment, to perform the process of transferring substrates in the track lithography tool 100, robot assembly 140A and robot assembly 140B are similarly configured and include at least one horizontal motion assembly 142, a vertical motion assembly 144, and a robot hardware assembly 143 supporting a robot blade 145. Robot assemblies 140 are in communication with a controller 160 that controls the system. In the embodiment illustrated in FIG. 1, a rear robot assembly 148 is also provided.

The scanner 150, which may be purchased from Canon USA, Inc. of San Jose, Calif., Nikon Precision Inc. of Belmont, Calif., or ASML US, Inc. of Tempe Ariz., is a lithographic projection apparatus used, for example, in the manufacture of integrated circuits (ICs). The scanner 150 exposes a photosensitive material (resist), deposited on the substrate in the cluster tool, to some form of electromagnetic radiation to generate a circuit pattern corresponding to an individual layer of the integrated circuit (IC) device to be formed on the substrate surface.

Each of the processing racks 120A, 120B, 130, and 136 contain multiple processing modules in a vertically stacked arrangement. That is, each of the processing racks may contain multiple stacked coater/developer modules with shared dispense 124, multiple stacked integrated thermal units 134, multiple stacked integrated bake and chill units 139, or other modules that are adapted to perform the various processing steps required of a track photolithography tool. As examples, coater/developer modules with shared dispense 124 may be used to deposit a bottom antireflective coating (BARC) and/or deposit and/or develop photoresist layers. Integrated thermal units 134 and integrated bake and chill units 139 may perform bake and chill operations associated with hardening BARC and/or photoresist layers after application or exposure.

In one embodiment, controller 160 is used to control all of the components and processes performed in the cluster tool 100. The controller 160 is generally adapted to communicate with the scanner 150, monitor and control aspects of the processes performed in the cluster tool 100, and is adapted to control all aspects of the complete substrate processing sequence. The controller 160, which is typically a microprocessor-based controller, is configured to receive inputs from a user and/or various sensors in one of the processing chambers and appropriately control the processing chamber components in accordance with the various inputs and software instructions retained in the controller's memory. The controller 160 generally contains memory and a CPU (not shown) which are utilized by the controller to retain various programs, process the programs, and execute the programs when necessary. The memory (not shown) is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits (not shown) are also connected to the CPU for supporting the processor in a conventional manner. The support circuits may include cache, power supplies, clock circuits, input/output circuitry, subsystems, and the like all well known in the art. A program (or computer instructions) readable by the controller 160 determines which tasks are performable in the processing chamber(s). Preferably, the program is software readable by the controller 160 and includes instructions to monitor and control the process based on defined rules and input data.

It is to be understood that embodiments of the invention are not limited to use with a track lithography tool such as that depicted in FIG. 1. Instead, embodiments of the invention may be used in any track lithography tool including the many different tool configurations described in U.S. application Ser. No. 11/112,281, entitled “Cluster Tool Architecture for Processing a Substrate” filed on Apr. 22, 2005, which is hereby incorporated by reference for all purposes and including configurations not described in the above referenced application.

Generally, track lithography tools are used to dispense precise amounts of expensive lithography chemicals onto substrates to form thin, uniform coatings. For modern lithography processes, the volumes of chemicals, such as photoresist, dispensed per event are small, for example, ranging from about 0.5 ml to about 5.0 ml. The volume of chemical dispensed, and the flow rate during the dispense operation, among other variables, are controlled during the process of dispensing the lithography chemicals, for example, photoresist. Preferably, control of the dispense operations in a track lithography tool provide actual dispensed volumes with an accuracy of ±0.02 milliliters (ml) and repeatability from dispense event to dispense event of 3σ<0.02 ml.

A wide variety of photolithography chemicals are utilized in track lithography tools according to embodiments of the present invention. For example, photoresist, bottom anti-reflective coating (BARC), top anti-reflective coating (TARC), top coat (TC), Safier, and the like are dispensed onto the substrate. In some embodiments, after the selected chemical is dispensed, the substrate is spun to create a uniform thin coat on an upper surface of the substrate. Generally, to provide the levels of uniformity desired of many photolithography processes, dispense events start with a solid column of chemical. The flow rate is generally set at a predetermined rate as appropriate to a particular chemical deliver process. For example, the flow rate of the fluids is selected to be greater than a first rate in order to prevent the fluids from drying out prior to dispense. At the same time, the flow rate is selected to be less than a second rate in order to maintain the impact of the fluid striking the substrate below a threshold value.

As the dispense event is terminated, the fluid is typically drawn back into the dispense line, sometimes referred to as a suck-back process utilizing a suck-back valve. In some track lithography tools, the fluid is brought back into the dispense line about 1-2 mm from the end of the dispense nozzle, forming a reverse meniscus. This suck-back process prevents the lithography chemicals from dripping onto the substrate and prevents the chemicals from drying out inside the nozzle.

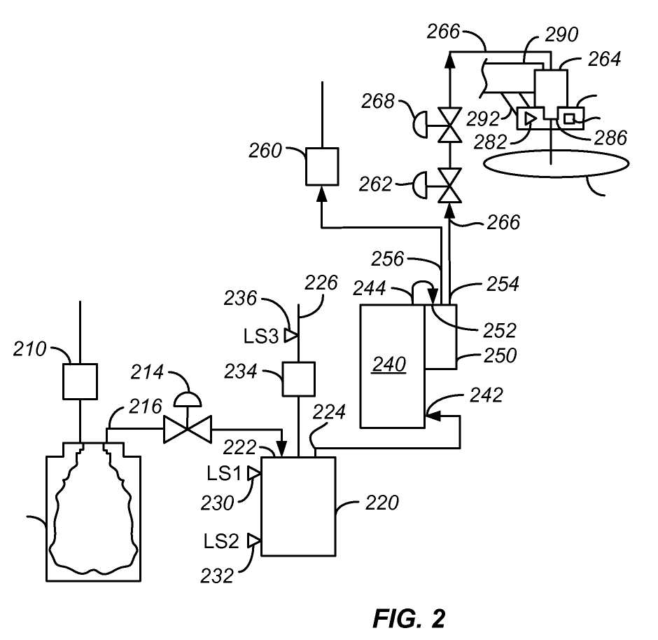

FIG. 2 is a simplified schematic illustration of a photolithography chemical dispense apparatus according to an embodiment of the present invention. A pressure valve 210 is coupled to a source bottle 212 containing the photolithography chemical to be dispensed onto the substrate surface. In an embodiment, the source bottle is a NOWPak® container available from ATMI, Inc., Danbury, Conn. The source bottle is coupled to a flow control valve 214 and adapted to regulate the flow of the photolithography chemical in fluid line 216. Buffer vessel 220 is illustrated in FIG. 2 and includes an input port 222, an output port 224, and a vent port 226. The input port 222 of the buffer vessel 220 is coupled to the fluid line 216. As illustrated in FIG. 2, the buffer vessel includes a number of level sensors, for example, level sensor LS1 (230) and level sensor LS2 (232). As described more fully below, the level sensors are utilized to regulate the volume of photolithography chemical present in the buffer vessel 220.

The vent port 226 of the buffer vessel is coupled to a vent valve 234 and a level sensor LS3 (236). Level sensor LS3 serves to monitor the level of fluid passing through the vent valve 234. The output port 224 of the buffer vessel is coupled to input port 242 of dispense pump 240. Dispense pump 240 includes a piston which moves a specific amount to deliver a quantity of liquid/fluid to the substrate. In an alternate embodiment a pressure vessel is used as described in U.S. Pat. No. 6,165,270, the full disclosure of which is incorporated herein by reference. As illustrated in FIG. 2, a filter 250 is integrated with the dispense pump 240 and the output port 244 of the dispense pump is coupled to an input port 252 of the filter 250. A vent port 256 and an output port 254 are provided on the filter 250 and, as illustrated in FIG. 2, a vent valve 260 is coupled to the vent port 256. A flow valve 262 is coupled to a suck back valve 268. A fluid line 266 running from the output port 254 of the filter is coupled to the flow valve. The suck back valve and flow valve are commercially are typically comprised in a single device. From valve 268, the photolithography chemical passes along fluid line 266 to a nozzle 264. The nozzle 264 dispenses photolithography chemicals to substrate 270. Nozzle 264 includes a nozzle tip 286 from which a liquid stream exits toward substrate 270. An arm 290 supports nozzle 264. Arm 290 is movable and positions the nozzle. A sensor package 280 includes a light source 282 and a digital optical sensor 284. A support 292 rigidly attaches the light source and the sensor to the arm. Nozzle 264 is removable from arm 290 and can be removed and replaced while the light source and the digital optical sensor remain attached to the arm. The sensor is adjustable on the arm and can be adjusted as needed to detect liquid at the tip of the nozzle. As will be evident to one of skill in the art, apparatus adapted to chuck and spin the substrate are not illustrated for purposes of clarity.

The flow valve and suck back valve can be acquired from several manufacturers and are typically available as a single unit. The suck back valve (SV) typically includes a pneumatic suck back valve. The pneumatic suck back valve includes a diaphragm. A gas is applied to the diaphragm under pressure to move the diaphragm. In some embodiments the suck back valve includes a digital suck back valve. The flow valve typically includes an air operated flow valve (AV) which opens as pressure is applied to the flow valve. A first electronic valve (EV) is provided to control gas to the flow valve, thereby controlling opening and closing of the flow valve with pressure. The flow valve opens when gas is supplied with pressure to the flow valve. The flow valve closes when the gas is exhausted. A second electronic valve (EV) is provided to control gas flow to the suck back valve. As gas is supplied to the suck back valve with pressure, the diaphragm moves to a reset position. As gas supplied to the diaphragm is exhausted, the diaphragm position will move to a suck back position. Thus, the suck back valve is actuated with gas pressure to do a reset, and gas is exhausted to do a suck back. The return of the diaphragm to the reset position provides increased fluid capacity coupled to the fluid line which sucks back the fluid in the line. Manufactures of suitable flow and suck back valves include SMC Digital of Indianapolis, Ind.; Koganei Corporation, Koganei City, Tokyo, Japan; and CKD USA Corporation, Rolling Meadows, Ill.

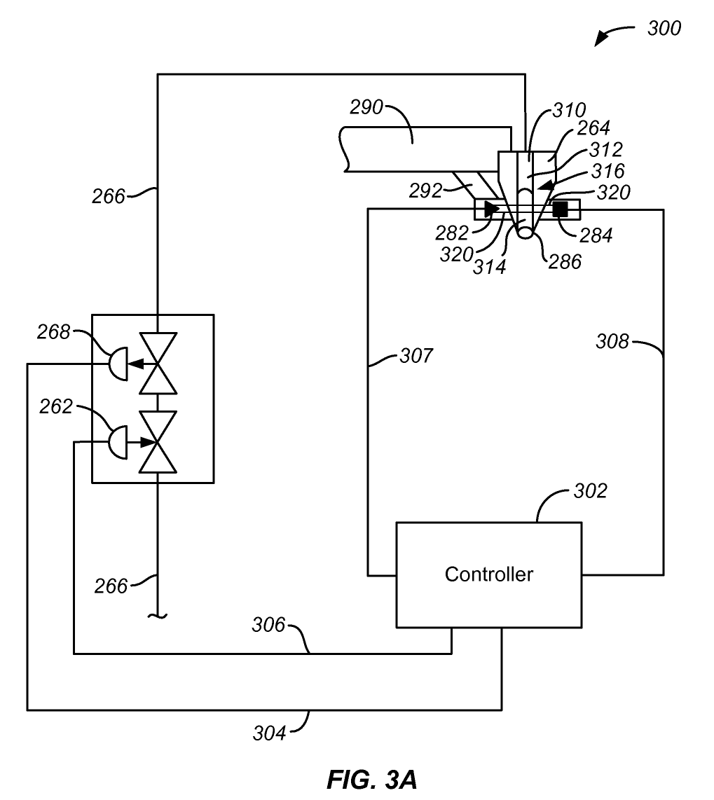

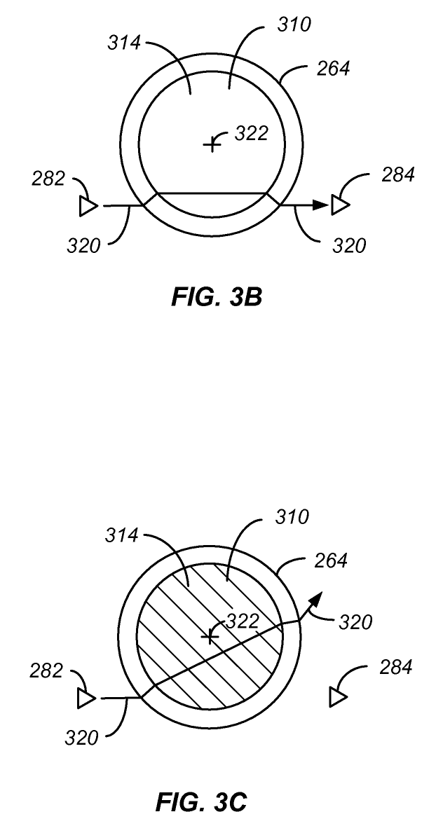

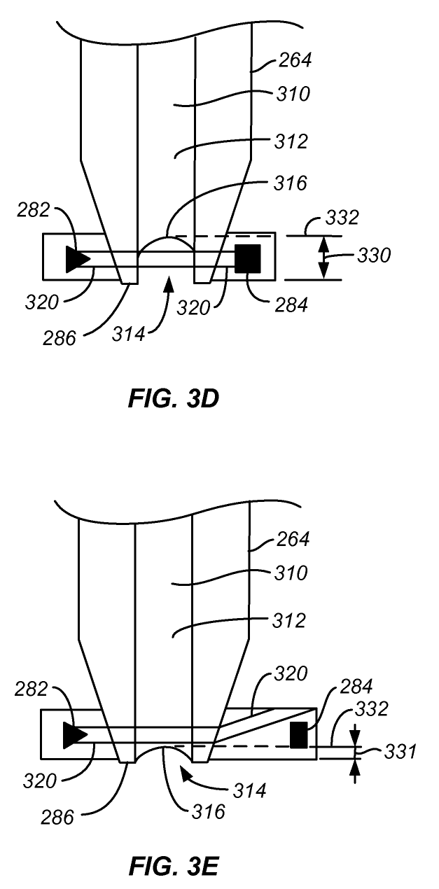

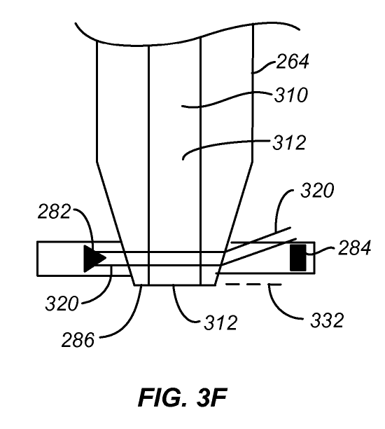

FIG. 3A is a simplified schematic illustration of digital optical sensor to detect liquid in a nozzle of a dispense apparatus according to an embodiment 300 of the present invention. Nozzle 264 includes a channel 310 formed therein. Channel 310 permits liquid to pass through the nozzle and exit the nozzle near the tip as a freely falling liquid stream. Channel 310 is formed in the nozzle so that the nozzle supports the liquid while the liquid is present in the channel. Light source 282 generates a light beam 320. Light beam 320 is transmitted through nozzle 264. A gas 314 is disposed in channel 310 near the light source and digital optical sensor 284. Liquid 312 has been drawn back away from nozzle tip 286 to form a reverse meniscus 316. In other words, liquid 312 has been “sucked back” away from nozzle tip 286 to form the reverse meniscus. Nozzle 264 includes a light transmissive material that transmits beam 320. In some embodiments, a portion of nozzle 264 comprises a light transmissive window that transmits light beam 320. As shown in FIG. 3A, light beam 320 is transmitted from light source 382 to digital optical sensor 284. Digital optical sensor 284 generates a digital signal in response to light reaching the sensor. Digital optical sensor 284 includes a threshold. Light reaching the sensor in excess of the threshold generates a digital signal indicating gas present in the nozzle near the sensor near the tip of the nozzle. Light reaching the sensor below the threshold value generates a digital signal indicating liquid present in the nozzle near the sensor near the tip of the nozzle.

A controller 302 is used to control the dispense of liquid through the nozzle and detect errors with the dispense of liquid. Controller 302 is connected to flow valve 262 with a control line 306, and flow valve 262 opens in response to commands from controller 302. Suck back valve 268 is connected to controller 302 with a control line 304, and suck back valve 268 draws fluid back from the nozzle toward the suck back valve in response to commands from the controller. Controller 302 is connected to light source 282 with a control line 307, and controller 302 can control an intensity of light generated by light source 282. Controller 302 is connected to digital optical sensor 284 with a digital sensor line 308. Digital sensor line 308 sends digital sensor data generated with digital optical sensor 284 to controller 302. While the controller can be any device which modifies an electrical signal, for example a phase comparator, a programmable array logic device or a microcontroller, the controller often comprises at least one microprocessor and at least one tangible medium for storing instructions for the controller. The tangible medium comprises random access memory (RAM) and can comprise read only memory (ROM), compact disk ROM (CDROM), flash RAM or the like. Controller 302 can comprise a distributed network of computers, for example a local area network, an intranet or Internet. Controller 302 communicates with processor 160, described above, and in some embodiments processor 160 comprises controller 302. Machine readable instructions for performing at least some of the techniques described herein are stored on the tangible medium. For example, controller 302 is programmed to receive a digital signal on digital sensor line 308 and generate and system error signal or a system OK signal in response to the digital signal from the digital optical sensor.

FIG. 3B shows a light beam transmitted from a light source to a sensor in a first direction while gas is disposed in the nozzle of FIG. 3A according to an embodiment of the present invention. A gas 314 is disposed in channel 310 near the tip of the nozzle and the sensors. The path of light beam 320 is offset from a center 322 of the nozzle. Light beam 320 is transmitted from the light source to the nozzle in a first direction and is refracted in the nozzle to exit the nozzle in substantially the same direction. Thus, the light beam refracted by the nozzle travels along a path from the nozzle to the sensor in the same direction as from the source to the nozzle, as shown in FIG. 3B. The amount of light energy reaching the detector is above the threshold amount so that the sensor generates a signal indicating a gas, for example air, is present near the tip of the nozzle. As a gas, for example air, is present in the channel, the surfaces of the nozzle cancel the optical power and refractive effects of the nozzle so that the light beam exits the nozzle in nearly the same direction as the light beam entered the nozzle. This can be explained because although the light beam is initially refracted by the outside surface of the nozzle having a positive refractive power as the light beam enters the nozzle, the inside surface of the nozzle at the channel has a negative refractive power which cancels the refractive effect of the outside surface of the nozzle. Similarly as the light beam exits the channel, the light beam is refracted by the nozzle with a negative refractive power and this is canceled by the positive refractive surface of the outside surface of the nozzle. As the outside of the nozzle has a conic form and the radius of curvature of the outside surface of the nozzle is greater than the radius of curvature of the inside surface of the nozzle, the light beam may in fact be refracted with a slight deflection as the beam exits the nozzle. Any such refractive deflection is correctable and minor compared to the refractive deflection of the beam which occurs while a liquid is present near the tip of the nozzle. For example, the position of digital optical sensor 284 can be slightly adjusted to correct for aberrations from the outside conic surface of the nozzle.

In an alternate embodiment, the position of the sensor is changed so that the light beam is refracted toward the sensor while the light beam passes through the liquid and is refracted away from the sensor while the light beam passes through a gas. For example the sensor can be located to receive light beam 320 while liquid is present.

FIG. 3C shows the light beam of FIG. 3B refracted in a second direction away from the sensor while liquid is disposed in the nozzle of FIG. 3A according to an embodiment of the present invention. A liquid 312 is disposed in channel 310 near the tip of the nozzle and the sensor. Light beam 320 is refracted away from digital optical sensor 284 as the light beam exits the nozzle. As the light beam is refracted away from the sensor, the amount of light reaching the sensor is substantially reduced. As shown in FIG. 3C, no light rays from the light source are able to reach the sensor so that the fluid in the column casts a shadow on the sensor. The light energy reaching the sensor falls below the threshold amount so that the digital optical sensor generates a signal indicating liquid is present near the nozzle tip.

FIG. 3D shows a simplified schematic illustration of a liquid in a nozzle drawn above a digital optical sensor to detect gas according to an embodiment of the present invention. A level 332 of liquid in the nozzle is drawn to a height 330 above nozzle tip 286. Reverse meniscus 316 is formed above light beam 320 so that light beam 320 passes through gas 314. As illustrated in FIG. 3B, light beam 320 is refracted toward digital optical sensor 284 and illuminates digital optical sensor 284. As the amount of light illuminating the digital optical sensor is above the threshold amount, digital optical sensor 284 generates a digital signal indicating gas is present in the nozzle near the tip.

FIG. 3E shows a simplified schematic illustration of a liquid in a nozzle drawn above a tip of a nozzle and below a digital optical sensor according to an embodiment of the present invention. Level 332 of liquid in the nozzle is drawn to a height 331 such that light beam 320 passes through liquid 312. As illustrated in FIG. 3C, light beam 320 is refracted away from digital optical sensor 284 so that the liquid and the nozzle cast a shadow on the digital optical sensor. As the amount of light illuminating the digital optical sensor is below the threshold amount, digital optical sensor 284 generates a digital signal indicating liquid is present in the nozzle near the tip.

FIG. 3F shows a simplified schematic illustration of a liquid in a nozzle flush with a tip of the nozzle and below a digital optical sensor according to an embodiment of the present invention. Light is refracted similarly to the embodiment of FIG. 3E.

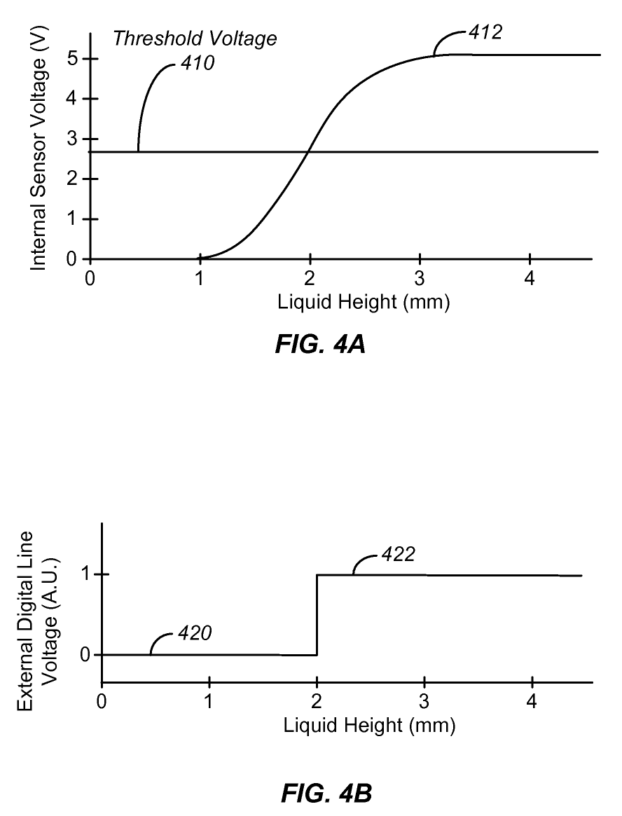

FIG. 4A illustrates a graph of an internal sensor voltage versus liquid height above a nozzle for a digital optical sensor with an adjustable threshold according to an embodiment of the present invention. Digital optical sensor 284 includes an internal digital optical sensor which generates an internal sensor voltage 412 in response to the light beam illuminating the digital optical sensor. This internal sensor voltage is compared to a threshold voltage 410. While internal sensor voltage 412 is below threshold voltage 410, the digital optical sensor generates a digital signal indicating liquid is present near the tip of the nozzle. While internal sensor voltage 412 is above threshold voltage 410, the digital optical sensor generates a digital signal indicating air is present near the tip of the nozzle. As described above, light beam 320 passes through the liquid and is refracted away from sensor 284 to generate a digital signal indicating liquid is present near the nozzle tip. As the height of the liquid above the tip approaches the height of the light beam above the tip, part of the light beam is refracted away from the sensor by the liquid and part of the light beam is refracted toward the sensor with the gas. As the height of the liquid above the nozzle tip increases, nearly all of the light is refracted toward the sensor and internal sensor voltage 412 approaches a maximum value. Components for building a digital optical sensor can be purchased from Yamatake of Phoenix Ariz.; and Omron of Schaumburg, Ill. The digital optical sensor can be constructed from the following components: Array beam plastic fiber cable, array width 5.25 mm, 2 m length, Free cut model; Digital indication auto-tuning fiber sensor amplifier, NPN output; PFA covered Thru. scan plastic fiber cable, 2 m length; M4 thread stainless steal head plastic Thru. scan fiber cable, Bend radius R2 mm, 2 m length, Free cut model; and Long scan distance lens unit, effective dia. 3 mm. Additional components which may be helpful in constructing the digital optical sensor include: Analog output for measuring liquid position; Digital output with adjustable threshold, PFA coated; and Digital output with adjustable threshold. These parts are available from the above suppliers.

FIG. 4B illustrates a graph of an external digital line voltage (arbitrary units) versus liquid height above a nozzle. An external digital line voltage of zero corresponds to a first digital signal 420 from the sensor corresponding to liquid near the tip of the nozzle. An external digital line voltage of 1 corresponds to a second digital signal from the sensor corresponding to gas near the tip of the nozzle.

Referring again to FIG. 4A, the threshold voltage 410 is adjusted so that the threshold voltage corresponds to a predetermined height of the liquid above the nozzle tip. For example, threshold voltage 410 can be adjusted so that the internal sensor voltage 412 equals the threshold voltage at a predetermined height of the liquid above the nozzle tip. The threshold voltage corresponds to the internal sensor voltage at which the external line voltage transitions from 0 to 1 in response to the internal sensor voltage above the threshold voltage and transitions from 1 to 0 in response to the internal sensor voltage below the threshold voltage. As shown in FIG. 4A, the threshold voltage corresponds to a height of 2 mm above the nozzle tip. Threshold voltage 410 can be adjusted to correspond with any desired liquid height above the nozzle, for example a height of 1.5 mm above the nozzle. An operator can be trained to visually adjust the threshold to correspond to a predetermined height of the liquid above the nozzle, for example 2 mm.

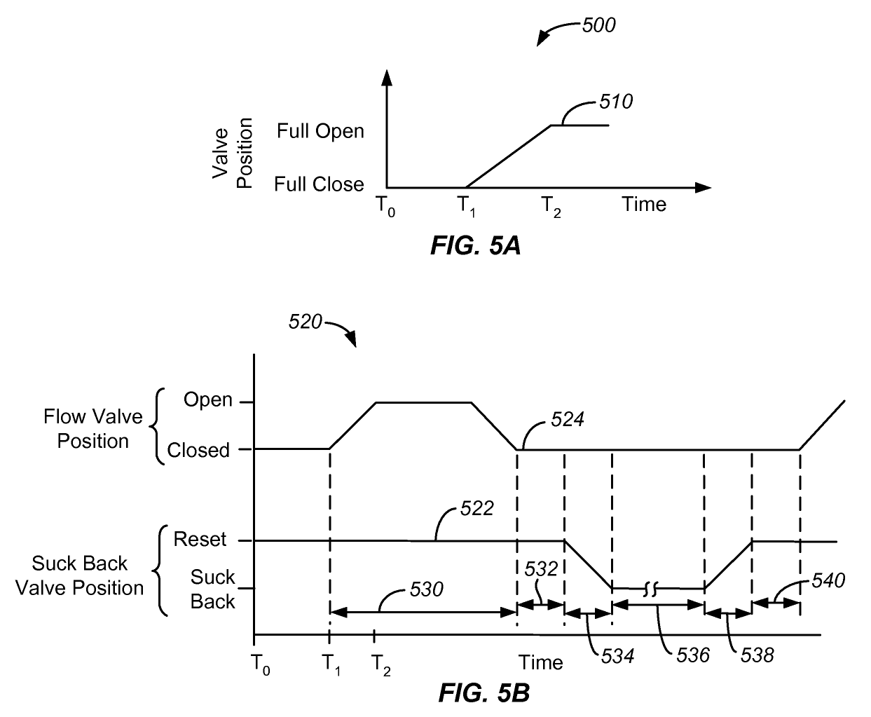

FIG. 5A shows a timing diagram 500 which illustrates opening a valve with a control signal 510 according to an embodiment of the present invention. At time T0 the valve is fully closed. In general this T0 refers to other events related to the valve, for example the time the pump starts or the time the controller sends a signal to start the pump. Thus, T0 also serves as a reference point. At time T1 the valve begins to open. At time T2 the valve is fully opened. The amount of time from T0 to T1 is known as the valve timing. To change the valve timing, the amount of time between time T0 and T1 is changed. The amount of time from time T1 to time T2 corresponds to the valve opening speed. To change the valve opening speed the amount of time between T1 and T2 is changed. These two parameters often have a similar effect, but this effect is not always identical and in some instance it may be desirable to adjust the valve timing after adjusting the valve speed as described more fully below.

FIG. 5B shows a timing diagram 520 which illustrates sequentially closing a flow valve and then exhausting a suck back valve after a period of time according to an embodiment of the present invention. A plot of a position 524 for a flow valve over time and a position 522 for a suck back valve over time are compared to show configurations of the flow valve and suck back valve over time. At time T1 the flow valve opens. A dispense operation 530 corresponds to an at least partially open flow valve and the suck back valve in a reset position as shown by positions 522 and 524 during dispense operation 530. While the dispense operation is performed, fluid is present in the nozzle unless there is a problem with the dispense. Near the end of dispense operation 530, the flow valve is closed to stop the fluid in the nozzle. Following dispense operation 530, a shutoff configuration 532 includes the flow valve in a closed position and the suck back valve in a reset position for a period of time, and the fluid is stopped in the nozzle when the system is working properly. While shutoff configuration 532 is maintained, the flow valve remains closed and the suck back valve remains in the reset position as shown by suck back valve position 522 and flow valve 524.

Following shut off configuration 532 the suck back valve draws fluid back from the nozzle with a suck back operation 534. While suck back operation 534 is performed, the flow valve remains closed and the suck back valve moves to the suck back position as shown by positions 522 and 524. The suck back valve draws fluid back from the nozzle by providing an increase in capacity coupled to the fluid line so that the fluid is drawn back from the nozzle to fill this increased capacity. Upon completion of suck back operation 534, gas is present at the tip of the nozzle when the system is working properly.

After suck back operation 534, the nozzle, suck back valve and flow valve remain in an idle configuration 536 with fluid drawn back from the nozzle. Idle configuration 536 is maintained until the next dispense. While idle configuration 536 is maintained, the flow valve remains closed and the suck back valve remains in a suck back configuration to provide the increased capacity. While idle configuration 536 is maintained, gas is present in the nozzle tip when the system is working properly. Following idle configuration 536, the suck back valve provides a reset operation 538. While reset operation 538 is performed the flow valve remains closed and the suck back valve transitions from the suck back configuration to reset configuration as shown by positions 522 and 524. While reset operation 538 is performed, the suck back valve removes the increased capacity provided with suck back operation 534, so that the liquid is extended toward the nozzle while the flow valve remains closed. Upon completion of reset operation 538, fluid is present near the tip of the nozzle when the system is working properly. A reset configuration 540 follows reset operation 538. The apparatus maintains reset configuration for a period of time. While reset configuration 540 is maintained, the flow valve remains closed and the suck back valve remains in the reset position as shown by positions 522 and 524. While reset configuration 540 is maintained, fluid is present in the nozzle tip when the system is working properly. Each of time period which corresponds to shut off configuration 532 and reset configuration 540 is typically very short, for example a range from 10 ms to 500 ms, and often about 100 ms. Following reset configuration 540 the cycle is repeated and the flow valve opens to initiate the dispense operation. The above cycle can be repeated many times with the same nozzle.

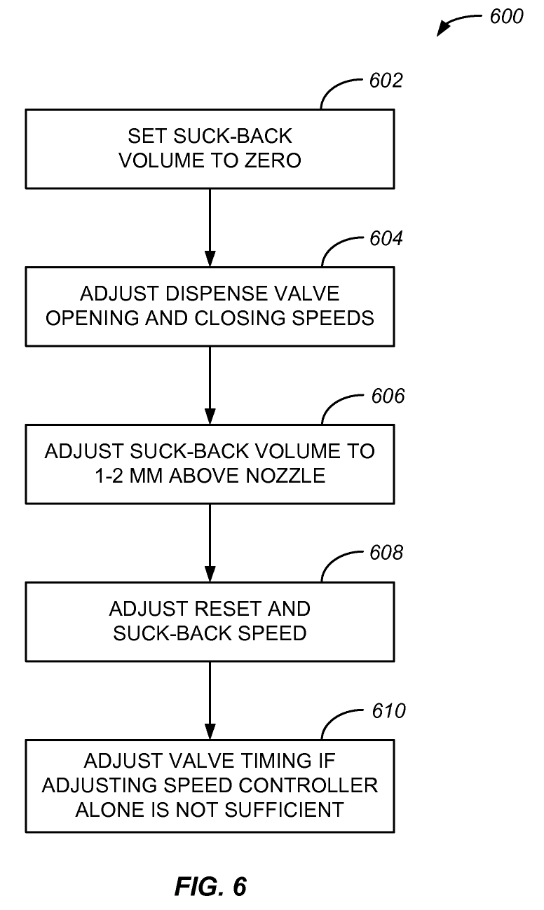

FIG. 6 shows a flow chart illustrating a method 600 of tuning a liquid delivery apparatus according to an embodiment of the present invention. These steps are performed by an operator who visually watches the nozzle. A step 602 sets the suck back volume to zero. After the suck back volume has been set to zero, a step 604 adjusts dispense valve opening and closing speeds. The flow valve is opened and closed and the opening and closing speeds are adjusted so that the fluid is flush with the tip of the nozzle when the valve closes at the end of the dispense operation. The dispense operation is repeated and the opening and closing speeds changed as many times as needed so that the liquid is flush with the tip of the nozzle at the end of the dispense operation. A step 606 adjusts the suck back volume to draw a predetermined volume of gas into the nozzle. In a particular embodiment, the predetermined volume of drawn gas raises the liquid 1 to 2 mm above the nozzle tip. A step 608 adjusts the reset and suck back speed so that the speed at which the reset operation and the suck back operation are performed correspond to a desirable rate. For example if suck back is too fast, it could leave a thin film inside the nozzle. Also, if reset is done too quickly, a drop can fall from the nozzle. A step 610 adjusts the valve timing if adjusting the speed controller alone at step 604 is not sufficient. When step 610 is performed, steps 604, 606 and 608 are usually repeated.

It should be appreciated that the specific steps illustrated in FIG. 6 provide a particular method of tuning a liquid delivery apparatus according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

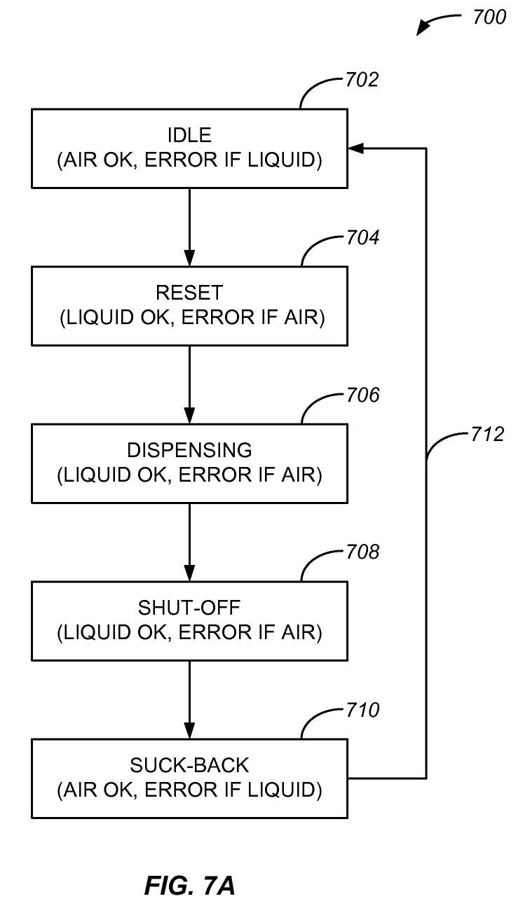

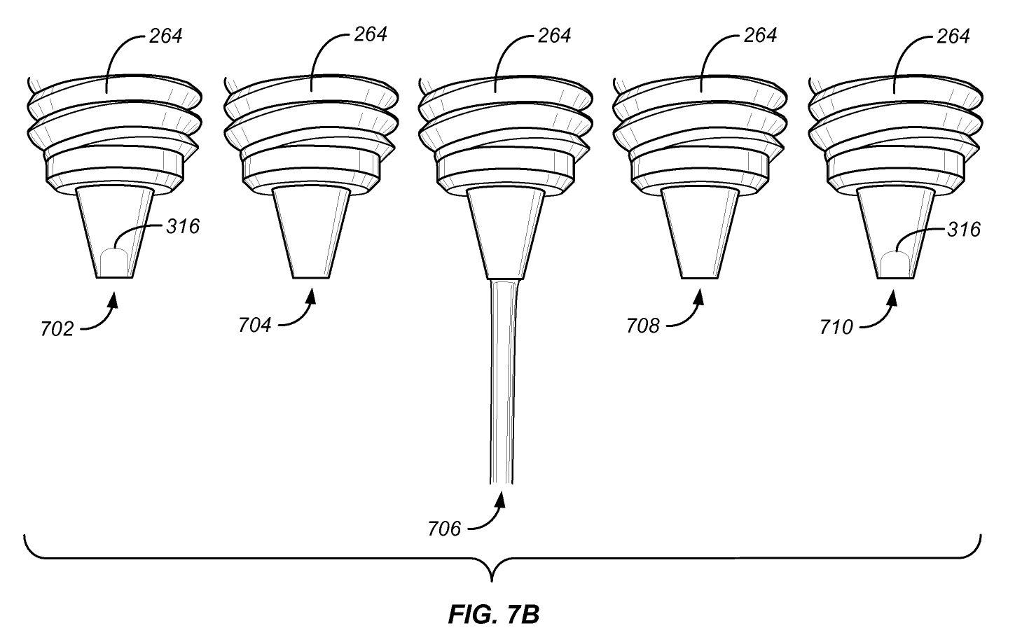

FIG. 7A shows a method 700 of dispensing a semiconductor process liquid to a substrate and monitoring to detect dispense errors according to an embodiment of the present invention. For each of the steps shown, the light source and sensor measure the nozzle tip to generate a digital signal as described above. A step 702 shows the error checking and the apparatus in an idle configuration as described above. If air is present, the controller generates an OK signal. If liquid is present the controller generates an error signal. A step 704 shows error checking and the apparatus in a reset configuration as described above. If liquid is present, the controller generates an OK signal. If air is present the controller generates an error signal. In some embodiments, step 704 also includes error checking near the end of the reset operation as described above. A step 706 shows error checking and the apparatus performing a dispense operation as described above. If liquid is present the controller generates an OK signal. If air is present the controller generates an error signal. A step 708 shows error checking and the apparatus in a shut off configuration as described above. If liquid is present, the controller generates an OK signal. If air is present the controller generates an error signal. A step 710 shows error checking and a suck back operation as described above. If air is present near the end of the suck back operation, the controller generates an OK signal. If liquid is present the controller generates an error signal. A step 712 shows the above monitoring to detect dispense errors repeated for subsequent cycles.

It should be appreciated that the specific steps illustrated in FIG. 7A provide a particular method of dispensing a semiconductor process liquid to a substrate and monitoring to detect dispense errors according to an embodiment of the present invention. Other sequences of steps may also be performed according to alternative embodiments. For example, alternative embodiments of the present invention may perform the steps outlined above in a different order. Moreover, the individual steps illustrated in FIG. 7A may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 7B shows sequential pictures from a method as in FIG. 7A with a nozzle in which no error has occurred according to an embodiment of the present invention. Step 702 includes nozzle 264 with liquid sucked back from the tip of the nozzle, and reverse meniscus 316 formed in nozzle 264. Step 704 includes liquid flush with the tip of nozzle 264 following the reset operation while the suck back valve and flow valve remain in a reset configuration. Step 706 shows liquid flowing from nozzle 264 while the dispense operation is performed. Step 708 shows nozzle 264 with liquid flush with the tip of the nozzle while the flow valve and suck back valve are in the shut off configuration. Step 710 shows nozzle 264 with liquid sucked back from the tip of the nozzle, and reverse meniscus 316 formed in nozzle 264 near the end of the suck back operation as described above.

While the present invention has been described with respect to particular embodiments and specific examples thereof, it should be understood that other embodiments may fall within the spirit and scope of the invention. The scope of the invention should, therefore, be determined with reference to the appended claims along with their full scope of equivalents.

What is claimed is:

1. A device for detection of a semiconductor process liquid, the device comprising:
a light source adapted to generate a light beam;
a digital optical sensor to detect the light beam; and
a nozzle adapted to support the semiconductor process liquid and transmit the light beam, the nozzle and the source arranged to refract the beam in a first direction while the beam passes through a gas disposed in the nozzle and to refract the beam in a second direction while the beam passes through the liquid.

2. The device of claim 1 wherein the first direction is toward the sensor and the second direction is away from the sensor.

3. The device of claim 1 wherein the sensor is offset from the beam transmitted in the second direction.

4. The device of claim 1 wherein the sensor generates first digital signal in response to liquid present in the nozzle and a second digital signal in response to gas present in the nozzle.

5. The device of claim 1 further comprising a support to support the nozzle, the source and the sensor, the support rigidly attached to the source and the sensor, the support adapted to permit removal and replacement of the nozzle while the source and the sensor remain attached to the support.

6. A device for detecting delivery errors with a semiconductor process liquid, the device comprising:
a nozzle to deliver the liquid, the nozzle comprising a tip;
a flow valve coupled to the nozzle to dispense the liquid through the nozzle;
a suck back valve to suck the liquid back from the nozzle tip;
a digital optical sensor to detect the liquid or a gas in the nozzle, the sensor adapted to generate a first signal while liquid is disposed in the nozzle and a second signal while a gas is disposed in the nozzle;
a processor coupled to the sensor, the processor adapted to generate an error signal in response to the second signal from the sensor while the flow valve dispenses liquid through the nozzle and/or in response to the first signal from the sensor while the suck back valve has sucked the liquid back from the tip.

7. The device of claim 6 wherein the sensor generates the first signal in response to liquid in the nozzle while the nozzle dispenses the liquid and generates the second signal in response to gas in the nozzle while the suck back valve has sucked the liquid back from the tip.

8. The device of claim 6 wherein the digital optical sensor comprises an adjustable threshold, wherein the threshold has been adjusted to generate the first signal or the second signal in response to a level of the liquid in the nozzle.

9. The device of claim 6 wherein the processor is adapted to generate the error signal in response to the second signal from the sensor while suck back valve has reset the liquid toward the tip and the flow valve remains closed.

10. The device of claim 9 wherein the liquid remains reset toward the tip for a period of time and the flow valve remains closed for the period of time, and wherein the sensor generates the first signal or the second signal in the time period.

11. The device of claim 6 wherein the processor is adapted to generate an error signal in response to the second signal from the sensor while the flow valve has stopped the liquid in the nozzle before the suck back valve sucks the liquid back from the tip.

12. The device of claim 11 wherein the liquid remains stopped in the nozzle for a period of time before the suck back valve sucks the liquid back from the tip and the sensor generates the first signal or the second signal in the time period.

13. The device of claim 6 further comprising:
a light source to generate a light beam; and
wherein at least a portion of the nozzle refracts the light beam away from the sensor while the beam passes through the liquid, and wherein the portion of the nozzle transmits the beam toward the sensor while the beam passes through the gas.

14. A method of applying a semiconductor process liquid through a nozzle, the method comprising:
opening a flow valve to dispense the liquid through the nozzle;
closing the flow valve to stop the liquid in the nozzle at a first level, the first level near a tip of the nozzle;
drawing the liquid back from the first level toward a second level away from the tip with a suck back valve while the flow valve remains closed; and
advancing the liquid from the second level to the first level with the suck back valve to reset liquid at the first level.

15. The method of claim 14 wherein the first level is flush with the tip of the nozzle.

16. The method of claim 14 wherein the flow valve remains closed with the fluid stopped in the nozzle for a period of time before the liquid is drawn toward the second level.

17. The method of claim 14 wherein the flow valve remains closed with the fluid stopped in the nozzle for a period of time after the suck back valve has reset the liquid at the first level.

18. A device for dispensing a semiconductor process liquid, the device comprising:
a light source to generate a light beam;
a digital optical sensor to detect the light beam;
a nozzle having a channel formed therein to dispense the liquid, the nozzle adapted to support the semiconductor process liquid and transmit the light beam, the nozzle and source arranged to refract the light beam in a first direction while a gas is disposed in the channel near the tip of the nozzle, the nozzle and source arranged to refract the light beam in a second direction while the liquid is disposed in the channel near a tip of the nozzle;
a flow valve to control a flow of the liquid through the nozzle, the flow valve open to dispense liquid through the nozzle and closed to stop the liquid in the nozzle near the tip;
a suck back valve adapted to suck the liquid back from the nozzle tip; and
a processor connected to the digital sensor, the flow valve and the suck back valve, the processor adapted to sequentially close the flow valve to stop the liquid for a period of time and open the suck back valve after the period of time while the flow valve remains closed, the processor adapted to generate an error signal in response to the beam refracted in the first direction in the time period and the gas detected with the sensor.

19. The device of claim 18 wherein the first direction is toward the sensor and the second direction is away from the sensor.

20. The device of claim 18 wherein the processor generates an error signal in response to liquid detected with the sensor after the liquid has been sucked back from the tip while the flow valve remains closed and the nozzle remains idle.

21. The device of claim 20 wherein the suck back valve resets the liquid toward the tip after the nozzle has remained idle and the liquid remains reset toward the tip for a period of time, and wherein the processor generates an error signal in response to air detected with the sensor in the time period.
